(19) United States
(12) Patent Application Publication
(10) Pub. No.: US 2018/0254681 A1
(43) Pub. Date: Sep. 6, 2018

(54) STATOR ASSEMBLY METHOD

(71) Applicant: AISIN AW CO., LTD., Anjo-shi, Aichi-ken (JP)

(72) Inventors: Shingo HASHIMOTO, Okazaki (JP); Shingo SATO, Okazaki (JP)

(73) Assignee: AISIN AW CO., LTD., Anjo-shi, Aichi-ken (JP)

(21) Appl. No.: 15/760,420

(22) PCT Filed: Sep. 14, 2016
(86) PCT No.: PCT/JP2016/077067

§ 371 Date: Mar. 15, 2018

(30) Foreign Application Priority Data
Sep. 30, 2015 (JP) 2015-195352

(51) Int. Cl. H02K 3/34; H02K 15/04; H02K 3/48; H02K 15/085; H02K 1/16; H02K 15/10

(52) U.S. Cl. CPC H02K 3/345; H02K 15/04; H02K 15/10; H02K 15/085; H02K 1/165; H02K 3/48

(57) ABSTRACT

A stator assembly method by which coils are mounted on an annular stator core, each of the coils including a plurality of in-slot portions formed of a conductor and a coil end portion formed of the conductor, the stator core including slots that are formed between adjacent teeth extending radially inward from a back yoke and that accommodate the in-slot portions.

### BACKGROUND

The present disclosure relates to a stator assembly method.

There is known a stator manufacturing method that includes a step of inserting coils into slots of an annular stator core. Such a stator manufacturing method is disclosed in, for example, Japanese Patent Application Publication No. 2011-193597 (JP 2011-193597 A).

According to the stator manufacturing method disclosed in JP 2011-193597 A, a jig and a plurality of coils are prepared. The jig has a cylindrical shape and has a plurality of holding grooves formed in the outer peripheral surface at the same pitch as that of the slots. The coils are each formed of a rectangular wire and having a pair of in-slot portions. An in-slot portion of one of the coils and an in-slot portion of another of the coils are inserted into a corresponding one of the holding grooves of the jig. The jig then is disposed on the inner side of the stator core such that the holding grooves and the slots communicate with each other, and the coils are deformed and pushed out from the radially inner side to the radially outer side. Consequently, the coils are inserted into the slots.

There is also known a coil insertion method that includes a step of inserting coils into slots of an annular stator core. Such a coil insertion method is disclosed in, for example, Japanese Patent Application Publication No. 2011-200107 (JP 2011-200107 A).

According to a coil insertion method disclosed in JP 2011-200107 A, insulating paper is disposed in slots of a stator core in advance, and coils are inserted while avoiding contact between the side surfaces of the coils and the walls of the teeth.

### SUMMARY

In the case of the stator manufacturing method disclosed in JP 2011-193597 A, when inserting coils each formed of a rectangular wire into the slots of the stator core, the side surfaces of the coils come into contact with the wall surfaces of teeth (portions defining the slots) of the stator core, so that the coils and insulating films of the coils may be damaged. In view of this, the coil insertion method disclosed in JP 2011-200107 may be applied to the stator manufacturing method disclosed in JP 2011-193597 A such that insulating paper is disposed in advance in slots of a stator core. However, in the case of deforming and inserting coils disposed on the radially inner side of a stator core as in JP 2011-193597 A into a stator core with insulating paper disposed thereon as in JP 2011-200107 A, a coil being inserted is deformed into an arcuate shape in the circumferential direction in a slot, so that the coil might come into pressure contact with the insulating paper, and displace the insulating paper. As a result, the side surfaces of the coil come into contact with the wall surfaces of teeth, so that the coil and the insulating film of the coil are damaged. JP 2011-193597 A also discloses use of a coil that is formed by bundling a plurality of round wires into a flat shape and winding an insulating sheet (insulating paper) therearound to maintain the flat shape. However, since insulating paper is wound around each of coils separately, the same number of sheets of insulating paper as the number of in-slot portions that are inserted in each slot need to be wound around the coils. This increases the time and effort needed to wind insulating paper.

An exemplary aspect of the disclosure provides a stator assembly method that can reduce the time and effort needed to assemble a stator while preventing damage to coils.

In order to achieve the above object, according to one aspect of the present disclosure, there is provided a stator assembly method by which coils are mounted on an annular stator core, each of the coils including a plurality of in-slot portions formed of a conductor and a coil end portion formed of the conductor, the stator core including slots that are formed between adjacent teeth extending radially inward from a back yoke and that accommodate the in-slot portions, the stator assembly method including: forming a coil assembly in which the coils are disposed in an annular arrangement; attaching insulating members to respective in-slot portion bundles, each of the in-slot portion bundles including the in-slot portions of at least two of the coils of the coil assembly; and in a state where the coil assembly to which the insulating members are attached is disposed on a radially inner side of the stator core, inserting the in-slot portions of the coils forming the coil assembly and the insulating members into the slots by pushing out the coils from a radially inner side to a radially outer side of the annular coil assembly.

With the stator assembly method according to the one aspect of the present disclosure, as described above, each insulating member is attached to the in-slot portion bundle including the in-slot portions of at least two coils of the coil assembly. Therefore, the insulating member can be attached to a plurality of the in-slot portions disposed in one slot at one time. Accordingly, unlike the case where the coils are inserted into the slots after placing the insulating members in the slots, the side faces of the coils and the wall surfaces of the teeth can be prevented from coming into contact with each other. Therefore, the coils and the insulating films of the coils can be prevented from being damaged by the inner wall surfaces of the teeth. Further, as compared to the case where the insulating member is attached to each of the in-slot portions, the time and effort needed to attach the insulating members can be reduced, and hence the assembly time of the stator can be reduced. That is, the assembly time of the stator can be reduced while preventing the coils from being damaged. Further, in a state where the coil assembly to which the insulating members are attached is disposed on the radially inner side of the stator core, the in-slot portions of the coils forming the coil assembly and the insulating members are inserted into the slots by pushing out the coils from the radially inner side to the radially outer side of the annular coil assembly. Accordingly, unlike the case where the coils are inserted into the slots after placing the insulating members in the slots, the insulating members are prevented from being buckled due to friction between the coils and the insulating members. This improves the yield in the assembly step of the stator.

According to the present disclosure, as described above, it is possible to reduce the time and effort needed to assemble a stator while preventing damage to the coils.

### BRIEF DESCRIPTION OF THE DRAWINGS

FIG. 1 is a partial plan view illustrating the inside of a stator according to an embodiment of the present disclosure.

FIG. 2 is a perspective view illustrating the configuration of the stator according to the embodiment of the present disclosure.

FIG. 3 is a cross-sectional view illustrating the configuration of an insulating sheet for the stator according to the embodiment of the present disclosure.

FIG. 4 is a perspective view illustrating the configuration of the insulating sheet for the stator according to the embodiment of the present disclosure.

FIG. 5 is a cross-sectional view illustrating the configuration of collars of the insulating sheet according to the embodiment of the present disclosure.

FIG. 6 is an explanatory diagram illustrating the configuration of coils disposed in a slot according to the embodiment of the present disclosure.

FIG. 7 illustrates the configuration of the concentrically wound coils disposed in slots as viewed from a radially inner side according to the embodiment of the present disclosure.

FIG. 8 is a perspective view of guide jigs according to the embodiment of the present disclosure.

FIG. 9 is an explanatory diagram illustrating a coil inserting step according to the embodiment of the present disclosure.

FIG. 10 is a perspective view illustrating the configuration of the coil according to the embodiment of the present disclosure.

FIG. 11 is an explanatory diagram illustrating a coil assembly forming step according to the embodiment of the present disclosure.

FIG. 12 is an explanatory diagram illustrating an insulating member attaching step (before attachment) according to the embodiment of the present disclosure.

FIG. 13 is an explanatory diagram illustrating the insulating member attaching step (after attachment) according to the embodiment of the present disclosure.

FIG. 14 is an explanatory diagram illustrating a step of attaching the guide jigs and a stator core to a coil assembly (before attachment) according to the embodiment of the present disclosure.

FIG. 15 is an explanatory diagram illustrating the step of attaching the guide jigs and the stator core to the coil assembly (a state in which some guide jigs are attached) according to the embodiment of the present disclosure.

FIG. 16 is an explanatory diagram illustrating the step of attaching the guide jigs and the stator core to the coil assembly (a state in which some guide jigs and the stator core are attached) according to the embodiment of the present disclosure.

FIG. 17 is an explanatory diagram illustrating the step of attaching the guide jigs and the stator core to the coil assembly (after attachment) according to the embodiment of the present disclosure.

FIG. 18 is an explanatory diagram illustrating a coil inserting step using the guide jigs (enlarged view before insertion) according to the embodiment of the present disclosure.

FIG. 19 is an explanatory diagram illustrating the coil inserting step using the guide jigs (enlarged view after insertion) according to the embodiment of the present disclosure.

FIG. 20 is an explanatory diagram illustrating the coils being inserted into the slot according to the embodiment of the present disclosure.

FIG. 21 illustrates the measurement results of the tensile strength of the material of the insulating sheet.

FIG. 22 illustrates the experiment results of the insulating sheet of the embodiment of the present disclosure and insulating sheets of comparative examples.

### DETAILED DESCRIPTION OF EMBODIMENTS

An embodiment of the present disclosure will be described with reference to the drawings.

[Configuration of Stator]

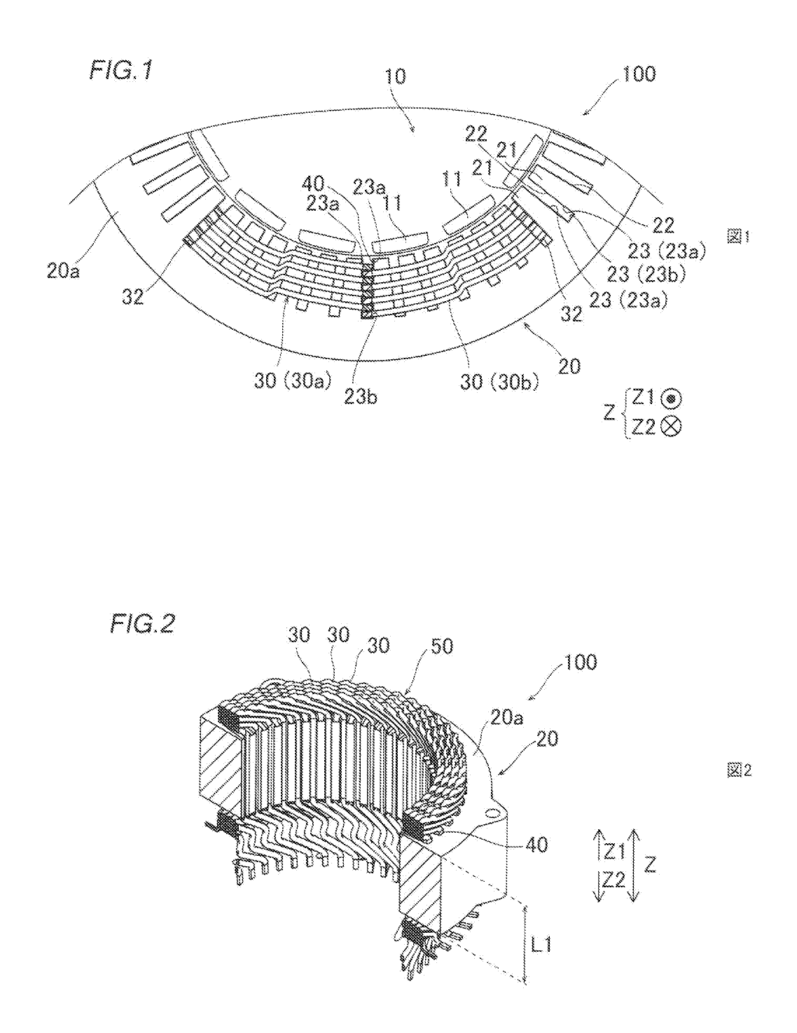

The structure of a stator 100 according to the present embodiment will be described with reference to FIGS. 1 to 7. The stator 100 according to the present embodiment is configured as a stator provided in a motor (rotary electric machine). Note that FIG. 1 illustrates the inside of the stator 100 as viewed from the axially upper side (arrow Z1 direction side) of a stator core 20. In the following description, the axial direction of the stator core 20 will be simply referred to as the “axial direction”; the circumferential direction of the stator core 20 will be simply referred to as the “circumferential direction”; and the radial direction of the stator core 20 will be simply referred to as the “radial direction”. Further, the radially outer side refers to the radially outer side of the stator core 20 (direction D1 in FIGS. 8, 18, and 19), and the radially inner side refers to the radially inner side of the stator core 20 (direction D2 in FIGS. 8, 18, and 19).

As illustrated in FIG. 1, a rotor core 10 includes a plurality of permanent magnets 11. The permanent magnets 11 are disposed at substantially equal intervals in the circumferential direction.

(Overall Configuration of Stator)

As illustrated in FIGS. 1 and 2, the stator 100 includes the stator core 20, coils 30 (concentrically wound coils), and insulating sheets 40. The insulating sheets 40 are an example of “insulating members”.

The stator core 20 is disposed to face the rotor core 10 in the radial direction. The stator core 20 includes a back yoke 20a formed in an annular shape, and a plurality of (for example, 48) teeth 21 extending radially inward from the back yoke 20a. The teeth 21 are disposed on the stator core 20 at substantially equal angular intervals in the circumferential direction. Further, slots 22 are formed between adjacent teeth 21. Further, as illustrated in FIG. 1, an inner wall surface 23 of each slot 22 includes inner wall surfaces 23a extending in the radial direction and disposed to face each other in the circumferential direction, and an inner wall surface 23b disposed on the radially outer side. Further, as illustrated in FIG. 2, the stator core 20 has a length L1 in the axial direction.

As illustrated in FIG. 2, each coil 30 is a cassette coil formed by coaxially winding a rectangular conductive wire having a substantially rectangular cross-sectional shape. The plurality of (for example, 48) coils 30 is disposed on the stator core 20 in the circumferential direction to form a coil assembly 50. In the case where the stator 100 is applied to a three-phase AC motor, each coil 30 serves as one of a U-phase coil, a V-phase coil, and a W-phase coil. The term “rectangular conductive wire” as used herein has broad meaning, including a rectangular conductive wire formed of a single conductive wire, and a conductive wire formed by bundling a plurality of thin wires together such that the outer cross-sectional shape thereof is the shape of a rectangular conductive wire (substantially rectangular shape).

As illustrated in FIG. 1, the insulating sheet 40 is disposed along the inner wall surface 23 (23a and 23b) of each of the slots 22. The insulating sheet 40 has a function of insulating the coils 30 from the slot 22.

(Configuration of Insulating Sheet)

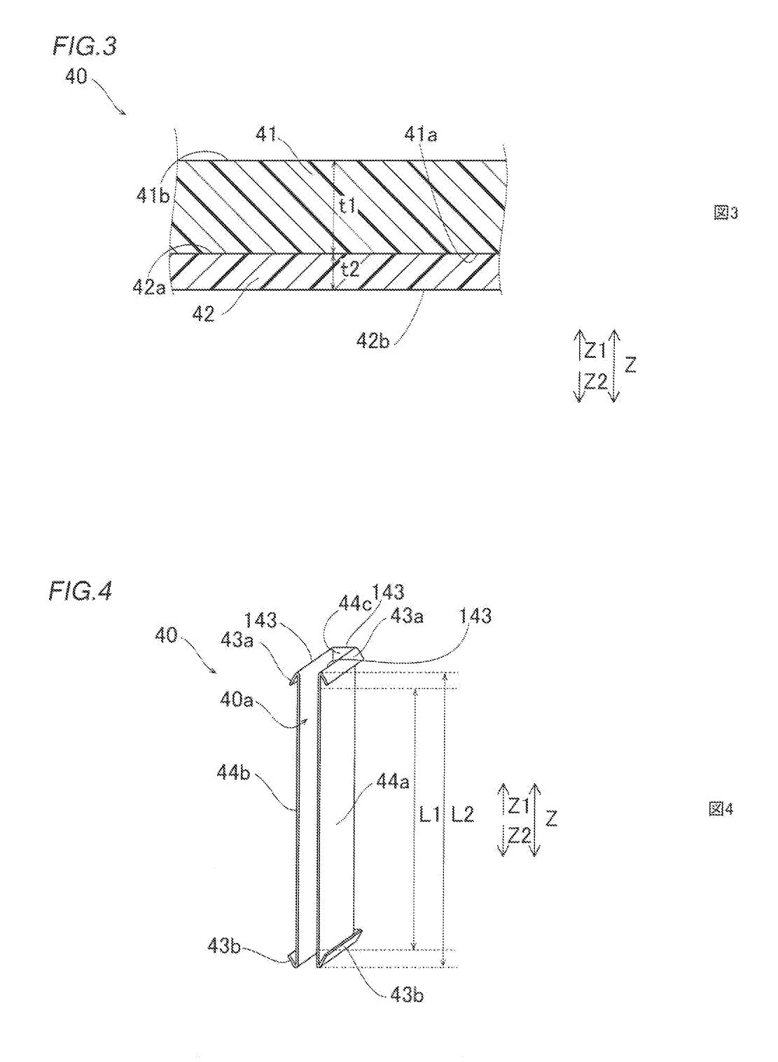

In the present embodiment, as illustrated in FIG. 3, the insulating sheet 40 has a two-layer structure including aramid paper 41 and a polymer film 42 that are directly joined together. The insulating sheet 40 is formed, for example, by plasma-treating a joint surface 41a of the aramid paper 41 and a joint surface 42a of the polymer film 42, and hot-pressing the plasma-treated aramid paper 41 and polymer film 42 that are directly stacked one on the other.

The aramid paper 41 is formed as, for example, aramid non-woven fabric. The aramid paper 41 is configured to form a surface 41b that serves as a sliding surface for the slot 22 when attaching the coils 30 to the slot 22. Note that the aramid paper 41 is an example of a “second layer”.

The polymer film 42 is, for example, a PEN (Polyethylene naphthalate) film, a PPS (Polyphenylenesulfide) film, or a PET (Polyethylene terephthalate) film. A PEN film and a PPS film have a higher heat resistance than a PET film. From this point of view, it is preferable to use a PEN film or a PPS film as the polymer film 42, and not to use a PET film. Note that the polymer film 42 is an example of a “first layer”.

The insulating sheet 40 with a two-layer structure is configured such that a thickness t1 of the aramid paper 41 is greater than a thickness t2 of the polymer film 42. For example, the insulating sheet 40 is configured such that the thickness t1 of the aramid paper 41 is two or more times greater than the thickness t2 of the polymer film 42.

Further, as illustrated in FIG. 4, the insulating sheet 40 has a shape extending along the inner wall surface 23 (see FIG. 1) of the slot 22. In the present embodiment, the insulating sheet 40 is formed to have a substantially U-shape as viewed from the axial direction, and a substantially rectangular shape as viewed from the circumferential direction. The substantially U-shaped insulating sheet 40 is formed to be bendable from the flat state, and has an opening 40a on the radially inner side. The opening 40a is an example of an “opening portion of the insulating member”.

The insulating sheet 40 includes collars 43a and 43b, and side faces 44a, 44b, and 44c. The collars 43a and 43b are disposed on the opposite sides in the axial direction (direction parallel to the Z-axis direction) of the insulating sheet 40, and are formed by bending the insulating sheet 40 in the direction parallel to the Z-axis to form a folding line 143 along the shape of the slot 22. The collars 43a and 43b are an example of a “portion of the insulating member”.

The insulating sheet 40 has a length L2 in the axial direction when the collars 43a and 43b and the side faces 44a to 44c are formed. The insulating sheet 40 is configured such that the length L2 of the insulating sheet 40 in the axial direction is greater than the length L1 of the stator core 20 in the axial direction.

As illustrated in FIG. 5, the collar 43a (and the collar 43b) is configured such that a portion of the insulating sheet 40 projects from the slot 22 to the arrow Z1 direction side, and is folded back to the arrow Z2 direction side (tooth 21 side). Thus, the collar 43a is disposed on the axially upper side (arrow Z1 direction side) of the tooth 21.

Further, in the present embodiment, as illustrated in FIG. 5, when the coils 30 are inserted into the slot 22, the collar 43a (and the collar 43b) is disposed between a first guide jig 61 (described below) and the coils 30. Thus, the collar 43a (and the collar 43b) provides a function to prevent the first guide jig 61 from directly contacting the coils 30, so that the coils 30 can be prevented from being damaged due to use of the first guide jig 61 when assembling the stator 100.

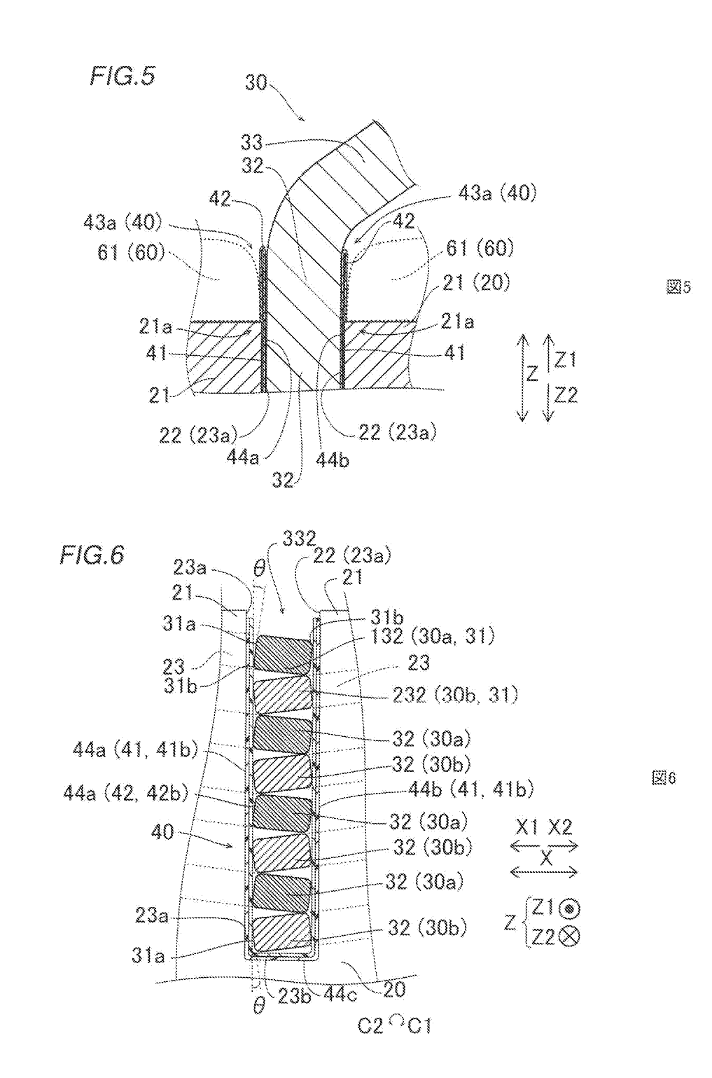

Further, as illustrated in FIG. 6, the side faces 44a and 44b are disposed to face the inner wall surfaces 23a of the slot 22. Specifically, the side face 44a is disposed to be held between the coils 30 and the tooth 21 on the arrow X1 direction side of the slot 22. Further, the side face 44b is disposed to be held between the coils 30 and the tooth 21 on the other side (arrow X2 direction side) of the side face 44a in the circumferential direction. Further, the side face 44c is disposed between the coils 30 and the teeth 21 in the radial direction.

In the present embodiment, as illustrated in FIG. 6, the outer surface 41b of the insulating sheet 40 (side faces 44a to 44c) is formed of the aramid paper 41, and an inner surface 42b of the insulating sheet 40 is formed of the polymer film 42. Thus, the aramid paper 41 is disposed on the stator core 20 side, and the polymer film 42 is disposed on the coil 30 side (in-slot portion 32 side).

Further, in the present embodiment, as illustrated in FIG. 6, a plurality of in-slot portions 32 (in-slot portion bundle 332) is stored in the slot 22, in the slot 22. Specifically, an in-slot portion 132 that is one of the paired in-slot portions 32 of one coil 30 (30a) and an in-slot portion 232 that is one of the paired in-slot portions 32 of another coil 30 (30b) are disposed in the slot 22. The insulating sheet 40 with a two-layer structure is configured to surround the in-slot portion 132 and the in-slot portion 232 together. That is, the insulating sheet 40 with a two-layer structure is configured to surround the in-slot portion bundle 332 including the in-slot portion 132 and the in-slot portion 232.

Specifically, in one slot 22, the in-slot portion 132 of the coil 30a that is wound a plurality of turns (for example, four turns) and the in-slot portion 232 of the coil 30b that is wound a plurality of turns are disposed to overlap each other in the radial direction. The insulating sheet 40 is disposed to surround the in-slot portions 132 and 232 overlapping in the radial direction (in-slot portion bundle 332) to have a substantially U-shape along the inner wall surface 23 of the slot 22.

(Configuration of Coil)

As illustrated in FIG. 6, each coil 30 is formed of a rectangular conductive wire 31 having a substantially rectangular cross-sectional shape. The rectangular conductive wire 31 is made of a highly conductive metal (for example, copper, aluminum, and the like). Note that the corners of the rectangular conductive wire 31 in cross section may be chamfered (rounded) into round shapes.

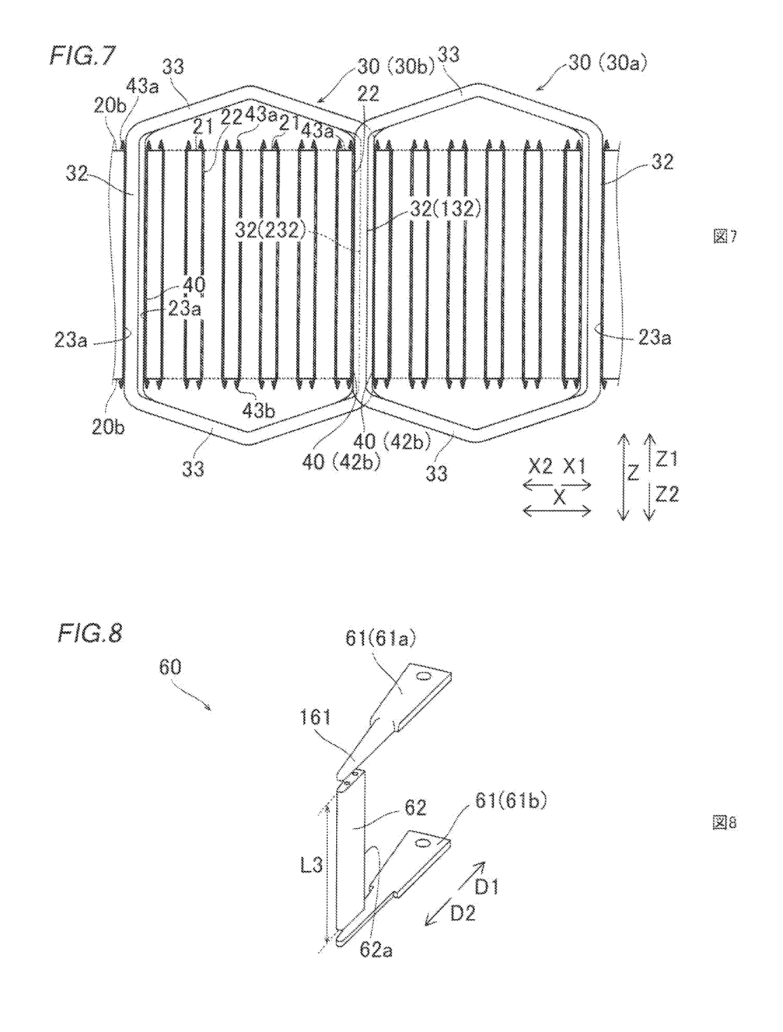

As illustrated in FIG. 7, the coil 30 is formed by winding a single linear rectangular conductive wire 31 a plurality of turns (for example, four turns) using a winding forming device (not illustrated), and then by bending the winding into a predetermined shape (for example, a substantially hexagonal shape or a substantially octagonal shape) using a shaping device (not illustrated).

In the present embodiment, as illustrated in FIG. 7, the coil 30 includes paired in-slot portions 32 formed of a conductor and accommodated in the slots 22, and a coil end portion 33 formed of the conductor and connecting the paired in-slot portions 32 to each other.

Specifically, the in-slot portions 32 are formed to extend parallel to the axial direction. Each in-slot portion 32 is accommodated in the slot 22, together with the in-slot portion 32 of another coil 30.

The coil end portion 33 includes a portion projecting to one side in the axial direction (arrow Z1 direction side), and a portion projecting to the other side (arrow Z2 direction side), from respective end faces 20b of the stator core 20. The coil end portion 33 has a curved shape along the circumferential direction as viewed from the axial direction (see FIG. 1).

In the present embodiment, as illustrated in FIG. 6, each in-slot portion 32 of each of the coils 30 is disposed such that a slot facing surface 31a of the rectangular conductive wire 31 facing the inner wall surface 23a of the slot 22 is inclined with respect to the inner wall surface 23a of the slot 22 as viewed from the axial direction.

Specifically, the slot facing surface 31a of the rectangular conductive wire 31 is inclined at an acute angle of θ (arrow C1 direction) with respect to the inner wall surface 23a of the slot 22 (side face 44a of the insulating sheet 40). While the slot facing surface 31a of the coil 30a is inclined at the acute angle of θ in the arrow C1 direction with respect to the side face 44a of the insulating sheet 40, the slot facing surface 31a of the coil 30b is inclined at the acute angle of θ (arrow C2 direction) with respect to the side face 44b of the insulating sheet 40. Thus, in the slot 22, the coils 30a and 30b are in contact with the insulating sheet 40, on the opposite sides in the circumferential direction.

Further, each coil 30 is disposed such that areas around two diagonally located corners 31b of the rectangular conductive wire 31 abut the surface 42b (polymer film 42) of the insulating sheet 40. Thus, the areas around the corners 31b of the rectangular conductive wire 31 are configured to press the insulating sheet 40 toward the inner wall surfaces 23a of the slot 22. Specifically, the corners 31b of the coil 30a are configured to press the insulating sheet 40 to the arrow X1 direction side, and the corners 31b of the coil 30b are configured to press the insulating sheet 40 to the arrow X2 direction side.

Further, as illustrated in FIG. 7, the rectangular conductive wire 31 (in-slot portion 32) is configured such that the substantially entire area thereof extending from one end of the slot 22 (arrow Z1 direction side) to the other end (arrow Z2 direction side) abuts the surface 42b (polymer film 42) of the insulating sheet 40. Further, the coil 30 is configured to press the insulating sheet 40 toward the inner side of the substantially hexagonally-shaped rectangular conductive wire 31.

### Effects of Configuration of Embodiment

With the configuration of the present embodiment, the following effects can be obtained.

In the present embodiment, the stator 100 includes: the annular stator core 20 including the slots 22 that are formed between the adjacent teeth 21 extending radially inward from the back yoke 20a and that accommodate the coils 30; and insulating sheets each of which is attached to the coils 30 and is formed to have a two-layer structure such that the aramid paper 41 forming the sliding surface (surface 41b) on the slot 22 side and the polymer film 42 forming the surface 42b on the opposite side of the surface 41b are directly joined. Thus, as compared to the case where an insulating sheet with a three-layer structure having the same total thickness as the insulating sheet 40 and including two layers of aramid paper and one layer of polymer film, the use of the insulating sheet 40 with a two-layer structure allows to increase the thickness t1 of the aramid paper 41 per layer. Therefore, the aramid paper 41 forming the sliding surface (surface 41b) can be prevented from being damaged (torn) when inserting the coils 30 into the slot 22. Accordingly, the insulating sheet 40 can be prevented from being damaged when placing the insulating sheet 40 between the stator core 20 and the coils 30.

Further, in the present embodiment, in the insulating sheet 40 with a two-layer structure, the thickness t1 of the aramid paper 41 is greater than the thickness t2 of the polymer film 42. Thus, since the thickness t1 of the aramid paper 41 is greater, it is possible to more reliably prevent the aramid paper 41 forming the sliding surface from being damaged.

[Configuration of Guide Jig]

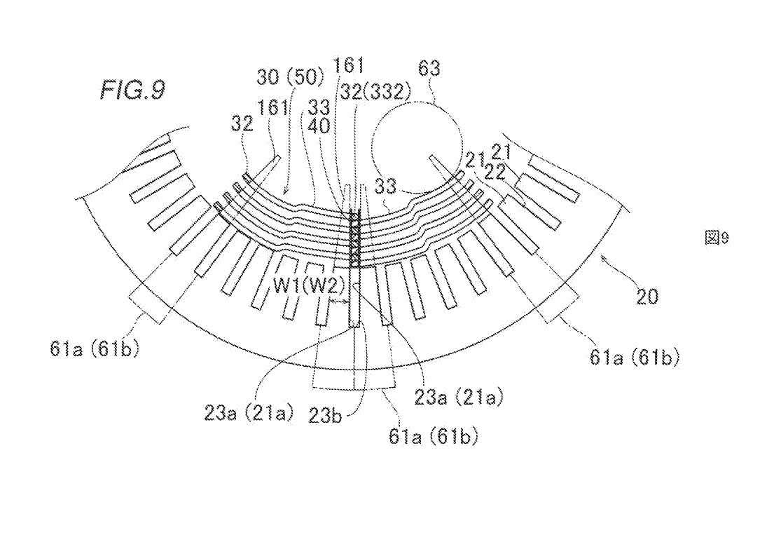

Next, a description will be given of a guide jig 60 that is used when assembling the stator 100 of the present embodiment, with reference to FIGS. 8 and 9.

As illustrated in FIGS. 8 and 9, the guide jig 60 includes the first guide jigs 61 and a second guide jig 62, and is configured to guide the coils 30 when inserting the in-slot portions 32 of the coils 30 into the slot 22.

As illustrated in FIG. 8, each of the first guide jigs 61 (first guide jigs 61a and 61b) is configured such that the width in the circumferential direction gradually decreases from the radially outer side toward the radially inner side as viewed from the axial direction. Further, the first guide jigs 61 are disposed one on each of the opposite sides of each tooth 21 in the axial direction when inserting the coils 30 into the slot 22. That is, the first guide jig 61a is disposed on the arrow Z1 direction side, and the first guide jig 61b is disposed on the arrow Z2 direction side.

Further, as illustrated in FIG. 8, each first guide jig 61 includes a portion 161 extending radially inward from the tooth 21. The portion 161 is configured to be inserted into a space (tooth hole 51, see FIG. 11) between the in-slot portion 32 of one of the adjacent coils 30 of the coil assembly 50 and the in-slot portion 32 of the other of the adjacent coils 30.

Further, as illustrated in FIG. 9, a width W1 of each first guide jig 61 in the circumferential direction at each radial position of the first guide jig 61 is equal to or greater than a width W2 of each tooth 21 in the circumferential direction at the same radial position as viewed from the axial direction. Note that FIG. 9 illustrates an example in which the width W1 and the width W2 are substantially equal. In the present embodiment, the first guide jig 61 is disposed to cover edge portions 21a of the tooth 21 extending in the radial direction as viewed from the axial direction. Thus, the coils 30 can be prevented from being damaged due to contact between the edge portions 21a and the coils 30 when the coils 30 inserted into the slot 22.

Further, as illustrated in FIG. 8, the portion 161 extending radially inward from the tooth 21 is chamfered into a round shape at the side remote from the side facing the tooth 21. Accordingly, even if the coils 30 come into contact with the portion 161 of the first guide jig 61, the coils 30 can be prevented from being damaged.

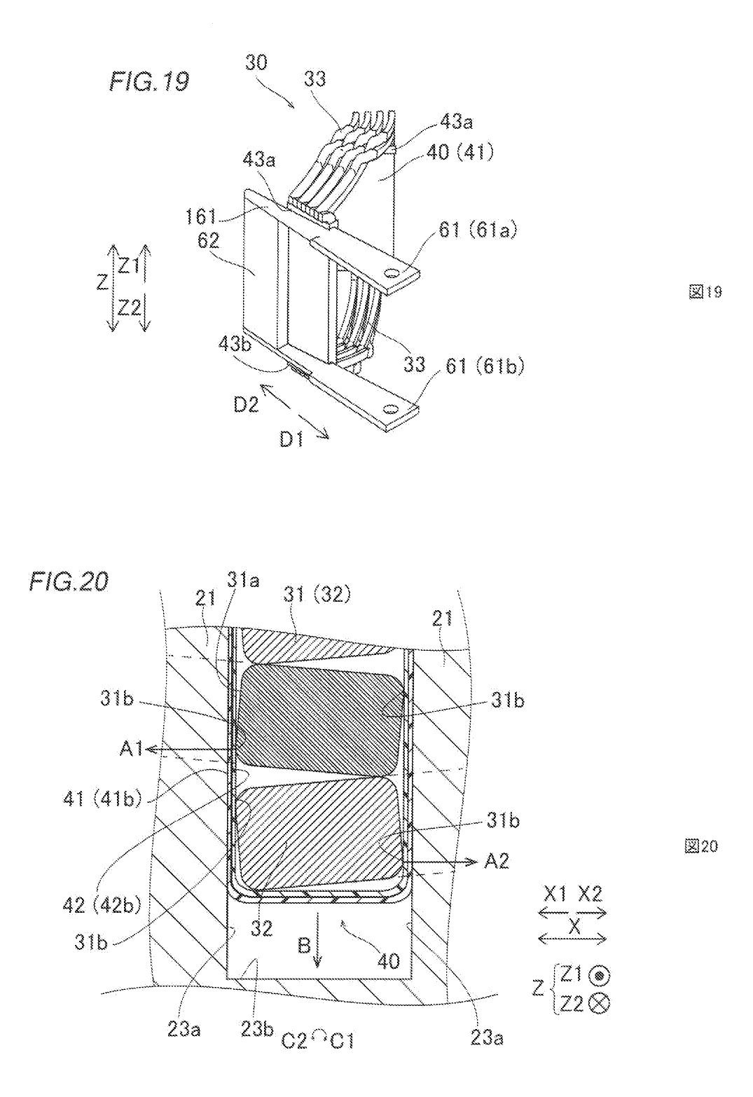

In the present embodiment, as illustrated in FIG. 9 (FIGS. 18 and 19), the first guide jig 61 (portion 161) is configured to, when the coils 30 and the insulating sheet 40 are inserted into the slot 22, guide the coils 30 while the collar 43a or 43b is disposed between the portion 161 of the first guide jig 61 and the coils 30. The details will be described below with reference to FIGS. 18 and 19.

As illustrated in FIG. 8, the second guide jig 62 has a plate shape, and is configured such that the width in the circumferential direction gradually decreases from the radially outer side toward the radially inner side as viewed from the axial direction. Further, the second guide jig 62 is disposed on the radially inner side of the tooth 21. Further, the second guide jig 62 is configured to, when the coils 30 are inserted into the slot 22, guide the in-slot portions 32 of the coils 30 in the circumferential direction while the side face 44a or 44b of the insulating sheet 40 is disposed between the second guide jig 62 and the in-slot portions 32. Further, a length L3 of the second guide jig 62 in the axial direction is substantially equal to the length L1 (see FIG. 2) of the stator core 20 in the axial direction.

[Stator Assembly Method]

Next, a method of assembling the stator 100 will be described with reference to FIGS. 2 to 4 and FIGS. 9 to 20.

(Insulating Member Forming Step)

As illustrated in FIG. 3, in an insulating member forming step, the insulating sheet 40 with a two-layer structure is formed. Specifically, the aramid paper 41 and the polymer film 42 are prepared. Further, the joint surface 41a of the aramid paper 41 and the joint surface 42a of the polymer film 42 are plasma-treated by a low-temperature plasma treatment machine (not illustrated). The plasma-treated aramid paper 41 and polymer film 42 then are stacked in the thickness direction (direction parallel to the Z-axis direction) and are hot-pressed to form the insulating sheet 40. With this method, the insulating sheet 40 is formed by directly joining the aramid paper 41 and the polymer film 42, without interposing an adhesive layer.

Further, as illustrated in FIG. 4, the insulating sheet 40 is bent from the flat state and formed into a substantially U-shape along the inner wall surface 23 of the slot 22 as viewed from the axial direction. Specifically, the collars 43a and 43b of the insulating sheet 40, the side faces 44a to 44c that are continuous to each other, and the opening 40a that is open to one side as viewed from the axial direction are formed by bending. That is, the insulating sheet 40 is a single continuous sheet, and has the opening 40a.

(Coil Assembly Forming Step)

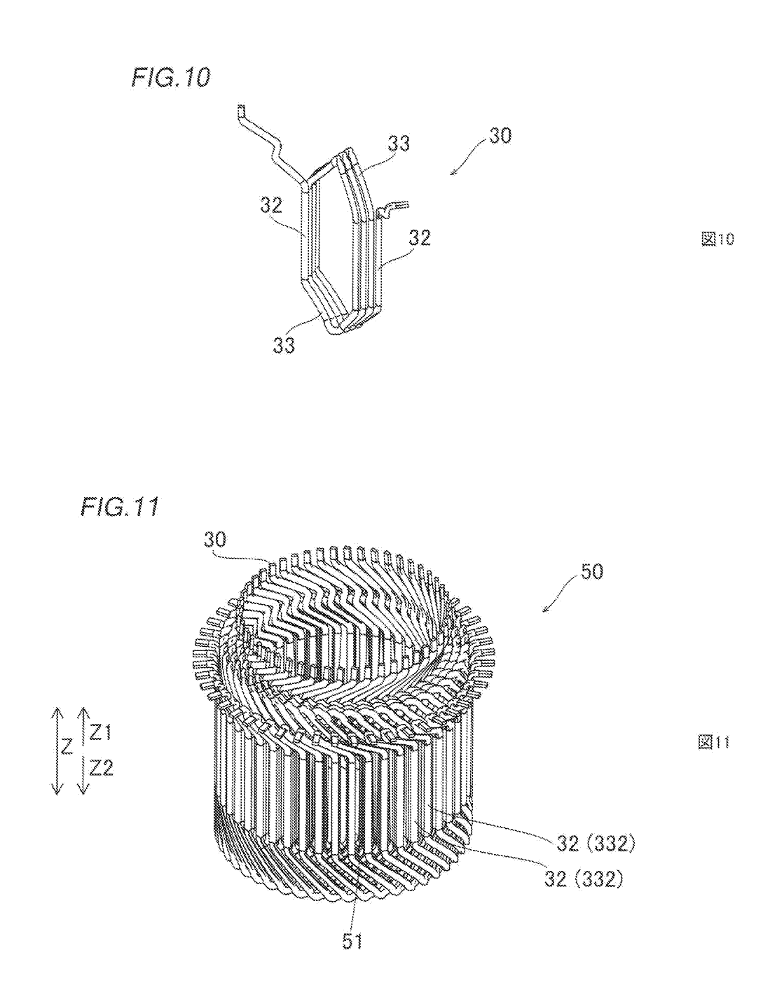

Next, as illustrated in FIGS. 10 and 11, in a coil assembly forming step, the coil assembly 50 in which the coils 30 are disposed in an annular arrangement is formed. Specifically, a plurality of the coils 30 illustrated in FIG. 10 is prepared. As illustrated in FIG. 11, the coils 30 then are disposed adjacent to each other in the circumferential direction and are displaced from each other by the pitch of the slots 22. Thus, the annular coil assembly 50 is formed.

In the present embodiment, as illustrated in FIGS. 6 and 11, each of the in-slot portion bundles 332 is formed such that the in-slot portions 32 (132 and 232) of two coils 30 disposed adjacent to each other in the circumferential direction are alternately arranged in the radial direction. Specifically, the coils 30 disposed adjacent to each other in the circumferential direction are disposed such that the rectangular conductive wires of the individual turns of one of the adjacent coils 30 and the rectangular conductive wires of the individual turns of the other of the adjacent coils 30 are alternately arranged in the stacking direction (radial direction) (see FIG. 6). Further, when the coil assembly 50 is formed of the coils 30, the tooth holes 51 for inserting the teeth 21 of the stator core 20 are formed between the coils 30 (in-slot portions 32) disposed adjacent to each other in the circumferential direction.

(Insulating Member Attaching Step)

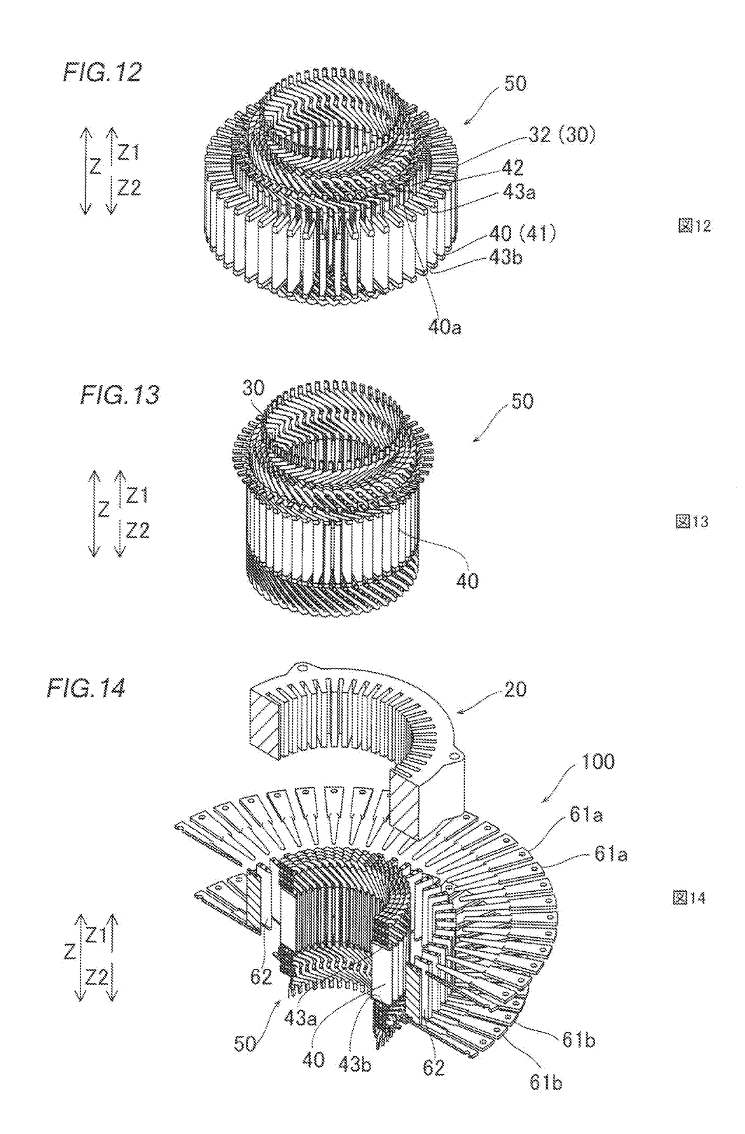

Next, as illustrated in FIGS. 12 and 13, in an insulating member attaching step, each insulating sheet 40 having the opening 40a that is open to one side as viewed from the axial direction is attached to the in-slot portion bundle 332 including the in-slot portions 32 (132 and 232) of at least two coils 30 of the coil assembly 50. In the present embodiment, as illustrated in FIG. 12, the same number of (for example, 48) insulating sheets 40 as the number of slots 22 are disposed on the radially outer side of the coil assembly 50 at equal angular intervals, with the openings 40a of the insulating sheets 40 facing the radially inner side. In other words, the insulating sheets 40 are disposed to face the in-slot portions 32 of the coils 30 in the radial direction. Further, the insulating sheets 40 are disposed such that the substantially U-shaped openings 40a of the insulating sheets 40 face the radially inner side (in-slot portion 32 side).

Next, as illustrated in FIGS. 12 and 13, the insulating sheets 40 are attached to the in-slot portions 32 of the coils 30 forming the coil assembly 50, from the radially outer side toward the radially inner side of the coil assembly 50. Thus, as illustrated in FIG. 9, each insulating sheet 40 is disposed so as to surround a plurality of the in-slot portions 32.

Further, in the present embodiment, the insulating sheets 40 disposed on the radially outer side of the coil assembly 50 as illustrated in FIG. 12 are attached from the radially outer side toward the radially inner side of the coil assembly 50 as illustrated in FIG. 13. Thus, each insulating sheet 40 with a two-layer structure is attached to the in-slot portions 32 such that the polymer film 42 is disposed on the coil 30 (in-slot portion 32) side. Note that the insulating sheets 40 may be fixed to the in-slot portions 32 by adhesive or the like.

(Guide Jig Inserting Step)

Next, in a guide jig inserting step, as illustrated in FIGS. 14 to 17, the guide jigs 60 (the first guide jigs 61a and 61b and the second guide jigs 62) are inserted into the coils 30 forming the coil assembly 50.

Specifically, as illustrated in FIG. 14, the coil assembly 50 with the insulating sheets 40 attached thereto, the guide jigs 60 (the first guide jigs 61 and the second guide jigs 62), and the stator core 20 are disposed in predetermined positions. For example, the guide jigs 60 are disposed on the radially outer side of the coil assembly 50, and the stator core 20 is disposed on one axial side (for example, the arrow Z1 direction side) of the coil assembly 50.

As illustrated in FIG. 15, the first guide jigs 61b disposed on one axial side (arrow Z2 direction side) and the second guide jigs 62 are inserted all at once into the respective tooth holes 51 of the coil assembly 50. In this step, the collar 43b (see FIG. 14) of each insulating sheet 40 is disposed between the first guide jig 61b and the coils 30. Note that although not illustrated, the jigs are configured such that the collars 43a and 43b of the insulating sheets 40 are hooked on the first guide jigs 61b as viewed from the axial direction, and the insulating sheets 40 are positioned by the first guide jigs 61.

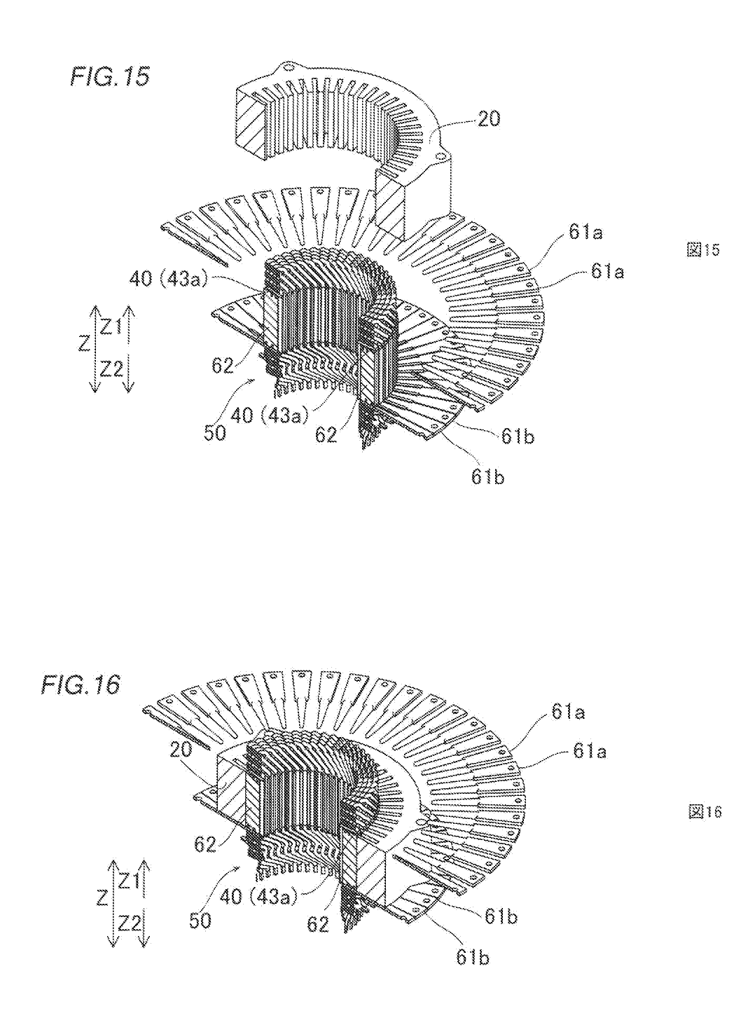

As illustrated in FIG. 16, the stator core 20 is moved relative to the coil assembly 50 in the axial direction, so that the coil assembly 50 is disposed in the radially inner space of the stator core 20. Specifically, the stator core 20 is moved with respect to the coil assembly 50 from a side (arrow Z1 direction side) of the coil assembly 50 to which the guide jigs 60 (first guide jigs 61b) are not attached, and is attached to the coil assembly 50.

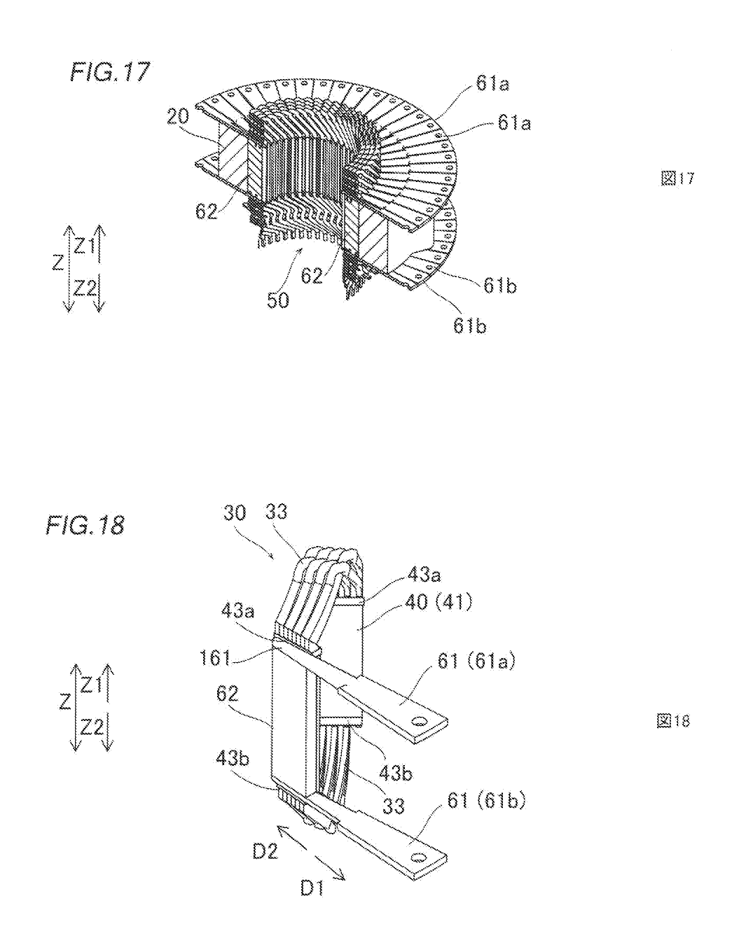

As illustrated in FIG. 17, the guide jigs 60 (first guide jigs 61a) are inserted into the coils 30 all at once from the radially outer side toward the radially inner side of the coil assembly 50. In this step, the collar 43a (see FIG. 16) of each insulating sheet 40 is disposed between the first guide jig 61a and the coils 30.

(Coil Inserting Step)

Next, as illustrated in FIGS. 2 and 9 and FIGS. 18 to 20, in a coil inserting step, in the state where the coil assembly 50 to which the insulating sheets 40 are attached is disposed on the radially inner side of the stator core 20, the in-slot portions 32 of the coils 30 forming the coil assembly 50 and the insulating sheets 40 are inserted into the slots 22 by pushing out the coils 30 from the radially inner side to the radially outer side of the annular coil assembly 50, while guiding the coils 30 by the first guide jigs 61 and the second guide jigs 62.

Specifically, as illustrated in FIG. 9, the coil end portion 33 of each coil 30 is pressed to the radially outer side of the stator core 20 by a roller 63. In this step, the roller 63 moves relative to the stator core 20 in the circumferential direction. Thus, the roller 63 gradually (partially) presses the coil end portion 33 from one side to the other side in the circumferential direction, in place of pushing the entire coil end portion 33 to the radially outer side of the stator core 20. Note that in FIG. 9, two coils 30 are disposed in one of the slots 22 of the stator core 20. However, in reality, two coils 30 are disposed in every slot 22.

In the present embodiment, as illustrated in FIG. 9, the in-slot portions 32 of the coils 30 and the insulating sheets 40 are inserted into the slots 22 by pushing out the coils 30 forming the coil assembly 50 from the radially inner side to the radially outer side while guiding the coils 30 by the first guide jigs 61 that are disposed to cover, on one axial side, the edge portions 21a of the teeth 21 extending in the radial direction and that extend radially inward from the teeth 21.

Specifically, as illustrated in FIGS. 18 and 19, the coils 30 and the insulating sheets 40 are inserted together into the slots 22, while the collars 43a and 43b of each insulating sheet 40 are disposed (held) between the portion 161 of the first guide jig 61 and the coils 30 and slide on the circumferential surface of the portion 161 of the first guide jig 61.

Further, in the present embodiment, as illustrated in FIGS. 18 and 19, when the coils 30 (coil assembly 50) are located on the radially inner side of the stator core 20 upon starting coil insertion in the coil inserting step, the coils 30 and the insulating sheets 40 are moved from the radially inner side to the radially outer side while the coils 30 are guided by the second guide jigs 62. Further, in this step, each second guide jig 62 guides the in-slot portions 32 in the circumferential direction while the side face 44a or 44b of the insulating sheet 40 is disposed between the second guide jig 62 and the in-slot portions 32.

Further, as illustrated in FIG. 20, in the coil inserting step, the rectangular conductive wire 31 forming the in-slot portion 32 is inserted together with the insulating sheet 40 into the slot 22 while being twisted in the arrow C1 direction or the arrow C2 direction as viewed from the axial direction (arrow Z1 direction side). That is, the coils 30 are inserted into the slot 22 by moving each rectangular conductive wire 31 from the inner diameter side to the outer diameter side of the stator core 20 (arrow B direction side) (inner wall surface 23b side) while the slot facing surface 31a of the rectangular conductive wire 31 is inclined with respect to the inner wall surface 23 of the slot 22 as viewed from the axial direction, and the areas around the corners 31b of the rectangular conductive wire 31 press the insulating sheet 40 toward the inner wall surface 23 (inner wall surfaces 23a) of the slot 22 (arrow A1 direction side and arrow A2 direction side).

Accordingly, the coils 30 are inserted into the slot 22 while the surface 41b of the aramid paper 41 of the insulating sheet 40 slides on the inner wall surfaces 23a. The coils 30 and the insulating sheet 40 then are moved together to reach near the inner wall surface 23b of the slot 22.

(Guide Jig Removing Step)

Next, as illustrated in FIG. 2, the guide jigs 60 are removed from the stator 100 (stator core 20). Specifically, the first guide jigs 61a and 61b (see FIG. 17) are moved from the radially inner side toward the radially outer side of the coil assembly 50, so that the first guide jigs 61a and the 61b are removed from the coil assembly 50. Next, the second guide jigs 62 (see FIG. 17) are moved from the stator core 20 in the axial direction, so that the second guide jigs 62 are removed. Thus, the assembly of the stator 100 is completed.

### Effects of Assembly Method of Embodiment

With the assembly method of the present embodiment, the following effects can be obtained.

In the present embodiment, each insulating sheet 40 is attached to the in-slot portion bundle 332 including the in-slot portions 32 (132 and 232) of at least two coils 30 of the coil assembly 50. Therefore, the insulating sheet 40 can be attached to a plurality of the in-slot portions 32 disposed in one slot 22 at one time. Accordingly, unlike the case where the coils 30 are inserted into the slots 22 after placing the insulating sheets 40 in the slots 22, the coils 30 and the inner wall surfaces 23 can be prevented from coming into contact with each other. Therefore, the coils 30 and the insulating films of the coils 30 can be prevented from being damaged by the inner wall surfaces 23. Further, as compared to the case where the insulating sheet 40 is attached to each of the pluralities of in-slot portions 32, the time taken to attach the insulating sheets 40 (specifically, the cycle time of each step) can be reduced, and hence the assembly time of the stator 100 can be reduced. That is, the assembly time of the stator 100 can be reduced while preventing the coils 30 from being damaged. Further, in the state where the coil assembly 50 to which the insulating sheets 40 are attached is disposed on the radially inner side of the stator core 20, the in-slot portions 32 of the coils 30 forming the coil assembly 50 and the insulating sheets 40 are inserted into the slots 22 by pushing out the coils 30 from the radially inner side to the radially outer side of the annular coil assembly 50. Accordingly, unlike the case where the coils 30 are inserted into the slots 22 after placing the insulating sheets 40 in the slots 22, the insulating sheets 40 are prevented from being buckled due to friction between the coils 30 and the insulating sheets 40. This improves the yield in the assembly step of the stator 100.

Further, in the case of the technique of winding an insulating sheet around an in-slot portion of each coil as disclosed in JP 2011-193597 A, two insulating sheets are held between in-slot portions that are inserted in the same slot. However, insulation between the coils is basically achieved by insulating films. Thus, from the view point of insulation, the insulating sheets disposed between the in-slot portions are unnecessary, and reduce the filling amount (space factor) of the coil in the slot. Meanwhile, in the present embodiment, the insulating sheet 40 is not disposed between the in-slot portions 32 inserted in the same slot 22. This provides an advantageous effect in that the filling amount (space factor) of the coil 30 in the slot 22 can be improved compared to the technique of JP 2011-193597 A.

Further, in the present embodiment, in the insulating member attaching step, each of the insulating sheets 40 that is a single continuous sheet, that has the opening 40a, and that is formed into a substantially U-shape as viewed from the axial direction is attached, with the opening 40a of the insulating sheet 40 facing the radially inner side, to the coil assembly 50 from the radially outer side toward the radially inner side. Thus, the insulating sheets 40 can easily be attached to the coils 30 of the coil assembly 50 by simply moving the insulating sheets 40 from the radially outer side toward the radially inner side of the coil assembly 50.

Further, in the present embodiment, in the coil inserting step, the in-slot portions 32 of the coils 30 and the insulating sheets 40 are inserted into the slots 22 by pushing out the coils 30 forming the coil assembly 50 from the radially inner side to the radially outer side while guiding the coils 30 by the first guide jigs 61 that are disposed to cover, on one axial side, the edge portions 21a of the teeth 21 extending in the radial direction and that extend radially inward from the teeth 21. Thus, with use of the first guide jigs 61, the coils 30 are less likely to come into contact with the edge portions 21a of the teeth 21 extending in the radial direction, so that the coils 30 can be prevented from being damaged due to contact with the edge portions 21a.

Further, in the present embodiment, in the coil inserting step, the in-slot portions 32 of the coils 30 and the insulating sheets 40 are inserted into the slots 22, while the collar 43a (or 43b) of each insulating sheet 40 is disposed between a corresponding one of pluralities of the coils 30 and a corresponding one of the first guide jigs 61 disposed on at least one axial side of a corresponding one of the teeth 21. Thus, the coils 30 are prevented from coming into contact with the first guide jig 61 and being worn, and therefore the coils 30 can be more reliably prevented from being damaged.

Further, in the present embodiment, in the coil inserting step, when the coil assembly 50 (coils 30) is located on the radially inner side of the stator core 20, the coils 30 and the insulating sheets 40 are moved from the radially inner side to the radially outer side while the coils 30 (in-slot portions 32) are guided by the second guide jigs 62 disposed on the radially inner side of the teeth 21. Thus, the coils 30 and insulating sheets 40 can be moved from the radially inner side to the radially outer side while preventing the coils 30 from being deformed (into a barrel shape) in the circumferential direction. Note that the side surface of each second guide jig 62 that guides the coils 30 is formed to be parallel to the side wall (inner wall surface 23) of the tooth 21. When the side surface of the second guide jig 62 is disposed together with the coil assembly 50 on the radially inner side (inner diameter side) of the stator core 20, the side wall (inner wall surface 23) of the tooth 21 and the side surface of the second guide jig 62 are substantially flush.

Further, in the present embodiment, in the coil assembly forming step, each of the in-slot portion bundles 332 is formed in which the in-slot portions 32 (132 and 232) of two coils 30 are alternately arranged in the radial direction. Generally, it is difficult to wind the insulating sheet 40 around each of the coils 30 of the in-slot portion bundle 332 in which the in-slot portions 32 (132 and 232) of two coils 30 are alternately arranged in the radial direction. In view of this, in the present embodiment using the insulating sheet 40 having the opening 40a, even in the case where the in-slot portion bundle 332 is configured as described above, the insulating sheet 40 can easily be attached to the in-slot portion bundle 332. Therefore, in this case, the time taken to attach the insulating sheets 40 can be especially effectively reduced.

Further, in the present embodiment, the insulating sheet 40 is formed to have a two-layer structure including the polymer film 42 and the aramid paper 41. Further, in the insulating member attaching step, each insulating sheet 40 is attached to the in-slot portions 32 such that the aramid paper 41 is disposed on the in-slot portion 32 side and the polymer film 42 is disposed on the side opposite to the in-slot portions 32. Thus, as compared to the case where an insulating sheet with a three-layer structure having the same total thickness as the insulating sheet 40 and including two layers of aramid paper and one layer of polymer film, the use of the insulating sheet 40 with a two-layer structure allows to increase the thickness t1 of the aramid paper 41 per layer. Therefore, the aramid paper 41 forming the sliding surface can be prevented from being damaged when the coils 30 are inserted into the slot 22. Further, since the polymer film 42 is disposed on the in-slot portion 32 side, the coils 30 can be inserted into the slot 22 while sliding the aramid paper 41 having a relatively great thickness, without sliding the polymer film 42 that is relatively easily broken due to sliding. Therefore, the insulating sheet 40 can be more reliably prevented from being damaged.

### Results of Comparative Experiment Between Embodiment and Comparative Examples

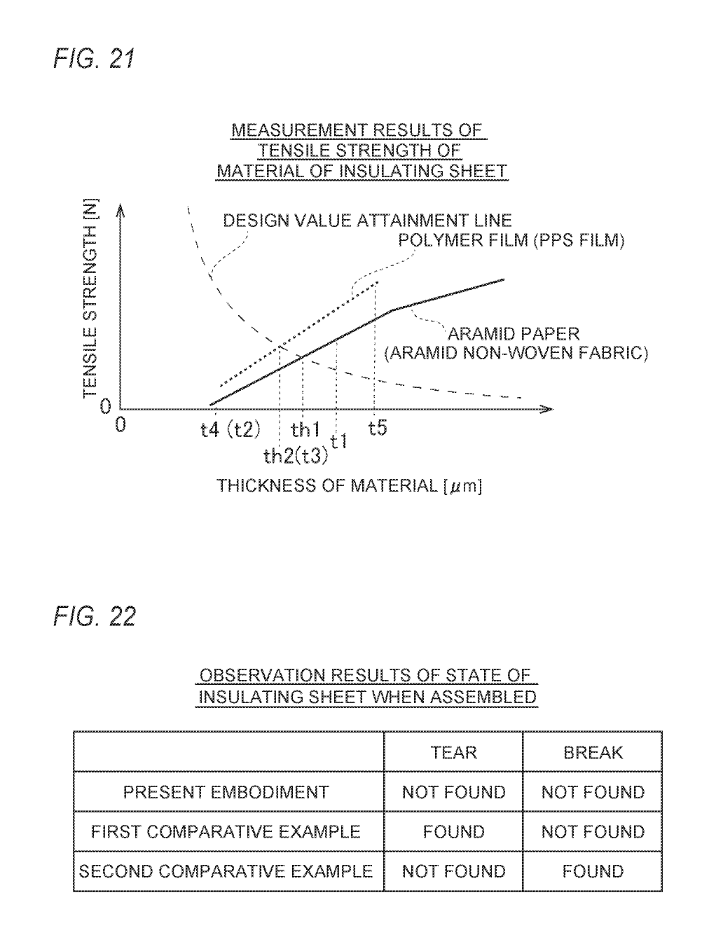

Next, the results of the comparative experiment between the insulating sheet 40 with a two-layer structure for the stator 100 of the present embodiment and insulating sheets for stators of comparative examples will be described with reference to FIGS. 21 and 22.

(Measurement Results of Tensile Strength of Aramid Paper and Polymer Film)

First, as illustrated in FIG. 21, the tensile strength with respect to the thickness of aramid paper and a polymer film (materials of an insulating sheet) was measured. Note that in FIG. 21, a design value attainment line (dotted line) is illustrated. The design value attainment line indicates the tensile strength corresponding to the assumed magnitude of pressure that is applied to the insulating sheet 40 when the stator 100 is assembled.

As illustrated in FIG. 21, it was found from the results of the experiment that the tensile string of the aramid paper 41 is greater than the tensile strength on the design value attainment line when the thickness is th1 or greater. It was also found that the tensile strength of the polymer film 42 is greater than the tensile strength on the design value attainment line when the thickness is th2 or greater.

(Observation Results of State of Insulating Sheet when Assembled)

Next, each of the insulating sheet 40 with a two-layer structure for the stator 100 of the present embodiment, an insulating sheet with a three-layer structure for a stator of a first comparative example, and an insulating sheet with a single layer of polymer film for a stator of a second comparative example was attached to the coils 30 and inserted into the slot 22, and then each insulating sheet was observed to determine whether there was a “tear” or “brake” in the insulating sheet. Note that a “tear” indicates a hole made in the material due to application of a load or a separation of joined layers, for example. Meanwhile, a “brake” indicates a state in which the material is split along one direction, for example.

The insulating sheet 40 with a two-layer structure for the stator 100 of the present embodiment used here was one with a two-layer structure including the aramid paper 41 having the thickness t1 (≥th1) (see FIG. 21) and the polymer film 42 having the thickness t2. Further, the insulating sheet with a three-layer structure for a rotary electric machine of the first comparative example used here was one with a three-layer structure including a polymer film having a thickness t3 and two sheets of aramid paper, each having a thickness t4 (<th1), disposed on the opposite side of the polymer film. Further, the insulating sheet with a single-layer structure for a rotary electric machine of the second comparative example used here was a polymer film having a thickness t5 (≥th2). Note that the insulating sheet 40 of the present embodiment and the insulating sheets of the comparative examples are formed to have the substantially same total thickness.

As illustrated in FIG. 22, it was found from the results of the experiment that the insulating sheet 40 with a two-layer structure for the stator 100 of the present embodiment hardly “tears” or “brakes”. Meanwhile, it was found that the insulating sheet with a three-layer structure for the rotary electric machine of the first comparative example “tears”. It was found that the insulating sheet with a single-layer structure for the rotary electric machine of the second comparative example “brakes”.

The above results revealed that the insulating sheet 40 with a two-layer structure for the stator 100 of the present embodiment is less easily “torn” or “broken” than the insulating sheets of the comparative examples. The above results also revealed that even if an insulating sheet is configured to have a tensile strength greater than the tensile strength on the design value attainment line, the insulating sheet with a single layer of polymer film “tears”.

[Modifications]

The presently disclosed embodiment should be considered in all respects to be illustrative and not restrictive.

For example, in the above embodiment, the coil assembly 50 is formed of the coils 30 each formed of the rectangular conductive wire 31. However, the present disclosure is not limited thereto. For example, a coil assembly may be formed of other types of coils, such as coils formed of a round wire, or wave wound coils.

Further, in the above embodiment, in the coil assembly 50, the coils 30 disposed adjacent to each other in the circumferential direction are disposed such that the rectangular conductive wires 31 of the individual turns of one of the coil 30 and the rectangular conductive wires 31 of the individual turns of the other one of coils 30 are alternately arranged in the stacking direction (radial direction). However, the present disclosure is not limited thereto. For example, in the coil assembly 50, the coils 30 may be disposed such that the in-slot portion 32 of each coil 30 forms a bundle.

Further, in the above embodiment, the first guide jigs 61 are disposed on both the one side and the other side of the tooth 21 in the axial direction. However, the present disclosure is not limited thereto. For example, if the coils 30 do not come into contact with the edge portions 21a of the tooth 21 when the coils 30 are inserted into the slot 22, the first guide jig 61 may be disposed only on one side or the other side of the tooth 21 in the axial direction.

Further, in the above embodiment, the coil assembly 50 is formed in a substantially cylindrical shape. However, the present disclosure is not limited thereto. For example, the coil assembly 50 may be formed in a tapered shape (conical shape) in cross section, with the radius gradually changing in the axial direction.

Further, in the above embodiment, the insulating sheet 40 is used as an example of an insulating member of the present disclosure. However, the present disclosure is not limited thereto. For example, a member that is formed in a three-dimensional shape different from a sheet shape may be used.

Further, in the above embodiment, in the insulating member attaching step, each insulating sheet 40 formed into a substantially U-shape as viewed from the axial direction is attached to the coil assembly 50, from the radially outer side toward the radially inner side. However, the present disclosure is not limited thereto. For example, the insulating sheet 40 may be attached to the coil assembly 50 by moving the insulating sheet 40 in the axial direction.

Further, in the above embodiment, the aramid paper 41 of the insulating sheet 40 is configured as aramid non-woven fabric. However, the present disclosure is not limited thereto. In the present disclosure, the aramid paper 41 of the insulating sheet 40 may be configured as paper in other forms than aramid non-woven fabric. For example, the aramid paper 41 may be configured as aramid woven fabric.

Further, in the above embodiment, the polymer film 42 of the insulating sheet 40 is a PEN film, a PPS film, or a PET film. However, the present disclosure is not limited thereto. In the present disclosure, the polymer film 42 of the insulating sheet 40 may be a polymer film other than a PEN film, a PPS film, and a PET film.

Further, in the above embodiment, the insulating sheet 40 with a two-layer structure is configured such that the thickness t1 of the aramid paper 41 is greater than the thickness t2 of the polymer film 42. However, the present disclosure is not limited thereto. In the present disclosure, the insulating sheet 40 with a two-layer structure may be configured such that the thickness of the aramid paper 41 is equal to or less than the thickness of the polymer film 42.

Further, in the above embodiment, the coil 30 is formed of the rectangular conductive wire 31. However, the present disclosure is not limited thereto. In the present disclosure, the coil 30 may be formed of a conductive wire having a circular shape with no corners in cross section.

Further, in the above embodiment, the coils 30 are inserted into the slot 22 while the slot facing surface 31a of each rectangular conductive wire 31 is inclined with respect to the inner wall surface 23 of the slot 22, and the areas around the corners 31b of the rectangular conductive wire 31 press the insulating sheet 40 toward the inner wall surface 23 of the slot 22. However, the present disclosure is not limited thereto. In the present disclosure, the coils 30 may be inserted into the slot 22 while the slot facing surface 31a of each rectangular conductive wire 31 is not inclined but is substantially parallel to the inner wall surface 23 of the slot 22.

Further, in the above embodiment, the coil assembly 50 (coils 30) is sequentially inserted into the slots 22 (stator core 20) by using the roller 63 (see FIG. 17). However, the present disclosure is not limited thereto. In the present disclosure, the entire coil assembly 50 (coils 30) may be inserted all at once into the slots 22 (stator core 20) without using the roller 63.

Further, in the above embodiment, each insulating sheet 40 is attached to the in-slot portion bundle 332 including the in-slot portions 32 (132 and 232) of two coils 30. However, the present disclosure is not limited thereto. In the present disclosure, each insulating sheet 40 may be attached to an in-slot portion bundle 332 including the in-slot portions 32 of three or more of the coils 30.

1. A stator assembly method by which coils are mounted on an annular stator core, each of the coils including a plurality of in-slot portions formed of a conductor and a coil end portion formed of the conductor, the stator core including slots that are formed between adjacent teeth extending radially inward from a back yoke and that accommodate the in-slot portions, the stator assembly method comprising:
forming a coil assembly in which the coils are disposed in an annular arrangement;
attaching insulating members to respective in-slot portion bundles, each of the in-slot portion bundles including the in-slot portions of at least two of the coils of the coil assembly; and
in a state where the coil assembly to which the insulating members are attached is disposed on a radially inner side of the stator core, inserting the in-slot portions of the coils forming the coil assembly and the insulating members into the slots by pushing out the coils from a radially inner side to a radially outer side of the annular coil assembly.

2. The stator assembly method according to claim 1, wherein when attaching the insulating members, each of the insulating members that is a single continuous member and that has an opening portion is attached, with the opening portion of the insulating member facing the radially inner side, to the coil assembly from the radially outer side toward the radially inner side.

3. The stator assembly method according to claim 2, wherein when inserting the in-slot portions of the coils, the in-slot portions of the coils forming the coil assembly and the insulating members are inserted into the slots by pushing out the coils from the radially inner side to the radially outer side while guiding the coils by first guide jigs that are disposed to cover, on one axial side, edge portions of the teeth extending in a radial direction and that extend radially inward from the teeth.

4. The stator assembly method according to claim 3, wherein when inserting the in-slot portions of the coils, the in-slot portions of the coils and the insulating members are inserted into the slots, while a portion of each of the insulating members is disposed between a corresponding one of pluralities of the coils and a corresponding one of the first guide jigs disposed on at least one axial side of a corresponding one of the teeth.

5. The stator assembly method according to claim 4, wherein when inserting the in-slot portions of the coils, when the coil assembly is located on the radially inner side of the stator core, the coils and the insulating members are moved from the radially inner side to the radially outer side while the coils are guided by second guide jigs disposed on a radially inner side of the teeth.

6. The stator assembly method according to claim 5, wherein when inserting the in-slot portions of the coils, each of the in-slot portion bundles is formed such that the in-slot portions of the at least two of the coils are alternately arranged in a radial direction.

7. The stator assembly method according to claim 6, wherein:
each of the insulating members is formed to have a two-layer structure including a first layer formed of a polymer film and a second layer formed of aramid paper; and
when attaching the insulating members, each of the insulating members is attached to a corresponding one of pluralities of the in-slot portions such that the first layer is disposed on an in-slot portion side and the second layer is disposed on a side opposite to the in-slot portions.

8. The stator assembly method according to claim 3, wherein when inserting the in-slot portions of the coils, each of the in-slot portion bundles is formed such that the in-slot portions of the at least two of the coils are alternately arranged in a radial direction.

9. The stator assembly method according to claim 8, wherein:
each of the insulating members is formed to have a two-layer structure including a first layer formed of a polymer film and a second layer formed of aramid paper; and
when attaching the insulating members, each of the insulating members is attached to a corresponding one of pluralities of the in-slot portions such that the first layer is disposed on an in-slot portion side and the second layer is disposed on a side opposite to the in-slot portions.

10. The stator assembly method according to claim 1, wherein when inserting the in-slot portions of the coils, the in-slot portions of the coils forming the coil assembly and the insulating members are inserted into the slots by pushing out the coils from the radially inner side to the radially outer side while guiding the coils by first guide jigs that are disposed to cover, on one axial side, edge portions of the teeth extending in a radial direction and that extend radially inward from the teeth.

11. The stator assembly method according to claim 10, wherein when inserting the in-slot portions of the coils, the in-slot portions of the coils and the insulating members are inserted into the slots, while a portion of each of the insulating members is disposed between a corresponding one of pluralities of the coils and a corresponding one of the first guide jigs disposed on at least one axial side of a corresponding one of the teeth.

12. The stator assembly method according to claim 11, wherein when inserting the in-slot portions of the coils, when the coil assembly is located on the radially inner side of the stator core, the coils and the insulating members are moved from the radially inner side to the radially outer side while the coils are guided by second guide jigs disposed on a radially inner side of the teeth.

13. The stator assembly method according to claim 12, wherein when inserting the in-slot portions of the coils, each of the in-slot portion bundles is formed such that the in-slot portions of the at least two of the coils are alternately arranged in a radial direction.

14. The stator assembly method according to claim 13, wherein:
each of the insulating members is formed to have a two-layer structure including a first layer formed of a polymer film and a second layer formed of aramid paper; and
when attaching the insulating members, each of the insulating members is attached to a corresponding one of pluralities of the in-slot portions such that the first layer is disposed on an in-slot portion side and the second layer is disposed on a side opposite to the in-slot portions.

15. The stator assembly method according to claim 1, wherein when inserting the in-slot portions of the coils, when the coil assembly is located on the radially inner side of the stator core, the coils and the insulating members are moved from the radially inner side to the radially outer side while the coils are guided by second guide jigs disposed on a radially inner side of the teeth.

16. The stator assembly method according to claim 15, wherein when inserting the in-slot portions of the coils, each of the in-slot portion bundles is formed such that the in-slot portions of the at least two of the coils are alternately arranged in a radial direction.

17. The stator assembly method according to claim 16, wherein:
each of the insulating members is formed to have a two-layer structure including a first layer formed of a polymer film and a second layer formed of aramid paper; and
when attaching the insulating members, each of the insulating members is attached to a corresponding one of pluralities of the in-slot portions such that the first layer is disposed on an in-slot portion side and the second layer is disposed on a side opposite to the in-slot portions.

18. The stator assembly method according to claim 1, wherein when inserting the in-slot portions of the coils, each of the in-slot portion bundles is formed such that the in-slot portions of the at least two of the coils are alternately arranged in a radial direction.

19. The stator assembly method according to claim 18, wherein:
each of the insulating members is formed to have a two-layer structure including a first layer formed of a polymer film and a second layer formed of aramid paper; and
when attaching the insulating members, each of the insulating members is attached to a corresponding one of pluralities of the in-slot portions such that the first layer is disposed on an in-slot portion side and the second layer is disposed on a side opposite to the in-slot portions.

20. The stator assembly method according to claim 1, wherein:
each of the insulating members is formed to have a two-layer structure including a first layer formed of a polymer film and a second layer formed of aramid paper; and
when attaching the insulating members, each of the insulating members is attached to a corresponding one of pluralities of the in-slot portions such that the first layer is disposed on an in-slot portion side and the second layer is disposed on a side opposite to the in-slot portions.
